(19) United States
(12) Patent Application Publication
(10) Pub. No.: US 2003/0125051 A1
(43) Pub. Date: Jul. 3, 2003

(54) Acknowledgement of reception of downlink messages

(76) Inventor: Arto Leppisaari, Tampere (FI)

Correspondence Address: PERMAN & GREEN, 425 POST ROAD, FAIRFIELD, CT, 06824, US

(21) Appl. No.: 10/033,598

(22) Filed: Dec. 27, 2001

(51) Int. Cl. H04Q 7/20

(52) U.S. Cl. 455/466; 455/515

(57) ABSTRACT

The invention relates to a method for acknowledging reception of messages in a communications system, which messages are downlink messages transmitted from a communication network to a mobile station connected to the communication network. In order to enable an efficient acknowledgement of downlink messages it is proposed that in a first step, at least two downlink messages are received at the mobile station from the communication network, of which at least two downlink messages reception has to be acknowledged. In a second step, the reception of the at least two downlink messages is then acknowledged in a single uplink message transmitted by the mobile station to the communication network. The invention equally relates to a corresponding mobile station, to a corresponding communication network and to a communication system comprising such a mobile station and such a communication network.

### FIELD OF THE INVENTION

The invention relates to a method for acknowledging the reception of messages in a communications system, which messages are downlink messages transmitted from a communication network to a mobile station connected to said communication network. The invention equally relates to such a mobile station, to such a communication network and to such a communication system.

### BACKGROUND OF THE INVENTION

It is known from the state of the art to enable an acknowledgement of downlink messages transmitted from a communication network to a mobile station, in order to inform the communication network whether the transmitted message was received.

For General Packet Radio Services (GPRS), in which mobile stations access a communication network via a GSM/EDGE (Global system for mobile communications/enhanced data rates for GSM evolution) radio access network (GERAN), such an acknowledgement of downlink messages is dealt with for example in the technical report 3GPP TS 44.060 V4.3.0 (2001-09): “Technical Specification Group GSM EDGE Radio Access Network; General Packet Radio Service (GPRS); Mobile Station (MS)—Base Station System (BSS) interface; Radio Link Control/Medium Access Control (RLC/MAC) protocol (Release 4)”.

The unidirectional physical connection between a mobile station and a communication network over the GSM/EDGE radio interface is called temporary block flow (TBF). For a TBF, which comprises a number of RLC/MAC radio blocks, radio resources are allocated on one or more packet data channels (PDCH). A TBF is maintained only for the duration of the respective data transfer.

Each TBF contains a control channel (PACCH), which is used to acknowledge the reception of data and of control messages that were contained in a TBF in the opposite direction. A downlink TBF is associated for example with the PACCH of a TBF in the uplink direction. This control channel in the uplink TBF is used to acknowledge the reception of data and of control message at the mobile station. An acknowledgement of the reception of control message is needed to ensure that the network knows whether the mobile station has received the message or not.

A mobile station may acknowledge a received control message for example upon polling by the network. The network is able to poll the mobile station to send an acknowledgment of reception by setting a RRBP (Relative Reserved Radio Block) field in the downlink control message which is to be acknowledged.

Upon reception of a such a polling request, the mobile station will respond to the network with a Packet Control Acknowledgement (PCA) message.

The RRBP field of the downlink control message also indicates an uplink radio block in the PACCH of the uplink TBF which is reserved for this PCA transmission. For enabling an adjustment of the time at which the PCA message is to be transmitted, the RRBP field comprises more specifically two bits that can be set. These bits indicate in a valid RRBP field the number of time division multiple access (TDMA) frames the mobile station shall wait before transmitting the uplink RLC/MAC block with the PCA. The delay achieved by a specific setting of the RRBP field is defined in the above cited technical report TS 44.060 relative to the first TDMA frame of the downlink block containing the RRBP value. The reserved uplink radio block is considered as a one block PACCH allocation and consist of four consecutive TDMA frames.

The above mentioned technical report TS 44.060 defines three different formats that can be employed for transmitting a PCA message in downlink direction. A first format is an RLC/MAC control block format, a second format is an 11-bit access burst format, and a third format is an 8-bit access burst format. These formats, of which the use is controlled by the network, are illustrated in FIG. 1, which was taken from the cited technical report TS 44.060.

FIG. 1 is a table which shows in its upper part the structure of an RLC/MAC control block that can be used for a PCA message. The block comprises a 32 bit TLLI field, a 2 bit CTRL_ACK field and padding bits. The entire block has a size of 176 bits. The TLLI field contains the temporary logical link identity (TLLI) of the mobile station. The CTRL_ACK field contains acknowledgement information for a group of downlink RLC/MAC control blocks that make up a downlink RLC/MAC control message. The mobile station sets the CTRL_ACK field to indicate which segments of a downlink RLC/MAC control message have been received by the time of transmission of the PCA message.

The table of FIG. 1 shows in its middle part the structure of an 11-bit access burst that can be employed for a PCA. The burst comprises a 9 bit MESSAGE_TYPE field and a 2 bit CTRL_ACK field. The MESSAGE_TYPE field has the value ‘111 1101’ and indicates that the message is a PCA message. The CTRL_ACK field corresponds to the CTRL_ACK field of the RLC/MAC control block.

The table of FIG. 1 shows in its lower part the structure of an 8-bit access burst that can be employed for a PCA. The structure of this burst is the same as the structure of the 11-bit access bursts, except that in this case, the MESSAGE_TYPE field comprises only 6 bits to which the values ‘0111 11’ are assigned.

If a PCA message is transmitting using one of the described access burst formats, the mobile station sends the same PCA in the four consecutive TDMA frames of the reserved radio block, the entire PCA message being formed by the four repetitions of the PCA.

The release 5 (Rel-5) of the GERAN specifications will enable mobile stations to access a 3G (3rd generation) core network via a GSM/EDGE radio access network. GERAN connects to the 3G core network via the lu interface, which is also used to connect UTRAN to the same 3G core network. This alignment between UTRAN and GERAN requires extensive changes in GERAN radio interface protocols.

GERAN and UTRAN will be used as an access for an internet protocol (IP) Multimedia Subsystem (IMS), which provides new multimedia services including rich call and presence services. An efficient provision of those new IMS services will require multiple simultaneous connections on the GERAN radio interface.

The current GPRS/EGPRS systems enable for each mobile station only a single TBF on the uplink and a single TBF on the downlink at the same time.

If a mobile station is running more than one application having different quality of service (QoS) requirements, the TBF has to be terminated and re-established each time when data from or to another application is transmitted. This causes unnecessary signaling and consumes radio resources.

Since multiple simultaneous services having different QoS requirements are very important for IMS, GERAN Rel-5 will contain the possibility to associate multiple simultaneous TBFs to one mobile station. Several downlink TBFs that are allocated to one mobile station can utilize the same or different radio resources, i.e. timeslots.

In the case of multiple TBFs, the uplink PACCHs associated to several downlink TBFs are using the same uplink timeslot. This is required to comply with the mobile station multislot class. FIG. 2 illustrates two examples of such an assignment of uplink PACCHs to the same timeslot.

A first example is depicted on the left hand side of FIG. 2. In the upper part of the left hand side, downlink timeslot numbers TN 0 to 7 are indicated. Timeslots 1-3 are assigned to three different downlink TBFs 1-3. Thus the downlink TBFs 1-3 are utilizing in this example the same radio resources. In the lower part of the left hand side, uplink timeslot numbers TN 0 to 7 are indicated. The same timeslot 2 is assigned to each of the respective uplink PACCHs associated to one of the downlink TBFs 1-3.

A second example is depicted on the right hand side of FIG. 2. In the upper part of the right hand side, again downlink timeslot numbers TN 0 to 7 are indicated. Timeslots 1 and 2 are assigned to a first downlink TBF 1, timeslots 2 and 3 are assigned to a second downlink TBF 2, and timeslot 2 is assigned to a third downlink TBF 3. Thus the downlink TBFs 1-3 are utilizing in this example only partly the same radio resources. In the lower part of the right hand side, again uplink timeslot numbers TN 0 to 7 are indicated. As in the first example, the same timeslot 2 is assigned to each of the uplink PACCHs associated to the TBFs 1-3.

If the network desires to receive an acknowledgement that a transmitted downlink control message was received correctly by the mobile station, the network uses also in the multiple TBF case the above described polling mechanism to assign an uplink radio block for the requested PCA message. Each control message of different downlink TBFs is acknowledged individually by a dedicated PCA message. An individual acknowledgement is satisfactory as long as only a single downlink TBF can be associated at the same time to each mobile station, since downlink control messages are sent rather seldom. In case of multiple TBFs, however, the amount of downlink control messages and thus of requested acknowledgements per mobile station increases. This will cause a significant increase of load to the uplink.

### SUMMARY OF THE INVENTION

It is an object of the invention to enhance the acknowledgement of downlink messages transmitted from a communication network to a mobile station. It is in particular an object of the invention to relieve the radio resources in the uplink required for acknowledging a plurality of downlink messages transmitted by the communication network to the same mobile station.

This object is reached with a method for acknowledging reception of messages in a communications system, which messages are downlink messages transmitted from a communication network to a mobile station connected to the communication network. It is proposed that the method comprises as a first step receiving at the mobile station at least two downlink messages from the communication network, of which at least two downlink messages reception has to be acknowledged. In a second step, reception of these at least two downlink messages is then acknowledged in a single uplink message transmitted by the mobile station to the communication network.

The object of the invention is further reached with a mobile station comprising means for combining acknowledgements for at least two downlink messages received from a communication network to which the mobile station is connected into a single uplink message to the communication network. The object of the invention is equally reached with a communication network comprising means for transmitting downlink messages to a mobile station connected to the communication network, and means for requesting an acknowledgement of at least two downlink messages transmitted to the mobile station in a single uplink message. Finally, the object of the invention is reached with a communication system comprising the proposed mobile station and the proposed communication network.

The invention proceeds from the idea that it is not necessary to acknowledge each downlink message addressed at a mobile station in a separate uplink message. Instead, the acknowledgement of two or more downlink messages could be transmitted in a single uplink message to the communication network.

It is an advantage of the invention that it enables saving uplink radio resources, since several downlink messages can be acknowledged with one uplink message.

Preferred embodiments of the invention become apparent from the subclaims.

The invention can be employed in particular, though not exclusively, for connections of mobile stations to a 3G core network via a GERAN.

The at least two downlink messages of which reception is to be acknowledged can be in particular control messages transmitted in at least two downlink TBFs associated to the mobile station.

The uplink message employed for acknowledging the reception of at least two downlink messages can be transmitted in particular in a control channel associated to a downlink TBF, which downlink TBF is associated to the mobile station. The uplink message is further preferably a single PCA message transmitted on a reserved uplink radio block of four consecutive TDMA frames of this control channel.

Advantageously, an uplink radio block that is to be employed for transmitting the uplink message acknowledging reception of the at least two downlink messages is identified in each of the at least two downlink messages.

Preferably, the uplink message acknowledging reception of at least two downlink messages comprises an identification of each of these downlink messages, in order to enable the network to associate the acknowledgement to individual downlink messages. If the downlink messages are transmitted using different TBFs, an identification of an acknowledged message could be given for instance by the number of a specific timeslot assigned to the TBF used for transmitting the downlink message. This specific timeslot can be in particular the number of the main, i.e. the first timeslot of all timeslots assigned for the TBF. An alternative identification could be the TFI allocated according to the above cited technical report TS 44.060 to each TBF.

The uplink message acknowledging reception of at least two downlink messages can be transmitted using different formats, e.g. either the RLC/MAC control block format or the access burst formats defined in the above cited technical report TS 44.060.

Since a message in the RLC/MAC control block can have a maximum size of 176 bits, while only 39 bits are required for MESSAGE_TYPE, TLLI and CTRL_ACK fields, there are up to 137 bits left for new fields. An RLC/MAC control block may thus comprise in addition e.g. up to four identification fields. Each of these identification fields is used for identifying a different one of up to four downlink message that are to be acknowledged. Any other number of identification fields than four can be used as well. Further, the number of included fields can be fixed or adapted to the respective number of downlink messages that are to be acknowledged.

If the uplink message acknowledging reception of at least two downlink messages is transmitted using an 8-bit or 11-bit access burst format, the uplink message is transmitted in four bursts distributed to four consecutive TDMA frames, as defined for the PCA message in the above cited technical report TS 44.060. An acknowledgement for each of up to four downlink messages can then be included in a different one of the four consecutive frames. In order to be able to use an access burst format, the current definition in the above cited technical report TS 44.060 has to be modified in a way that bits are available for inserting an identification of the respective downlink message of which reception is to be acknowledged. If the access burst format is employed, the radio block is used efficiently, since four different PCAs are sent during the radio block.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE FIGURES

In the following, the invention is explained in more detail with reference to drawings, of which

FIG. 1 is a table defining the format of PCAs according to the technical report TS 44.060;

FIG. 2 illustrates the use of timeslots for multiple TBFs in the downlink and associated PACCHs in the uplink;

FIG. 3 conceptually compares the known TBF acknowledgement to the TBF acknowledgement in an embodiment of the invention;

FIG. 4 is a table defining an RLC/MAC format used for PCAs in an embodiment of the invention; and

FIG. 5 is a table defining two access burst formats used alternatively for PCAs in an embodiment of the invention.

### DETAILED DESCRIPTION OF THE INVENTION

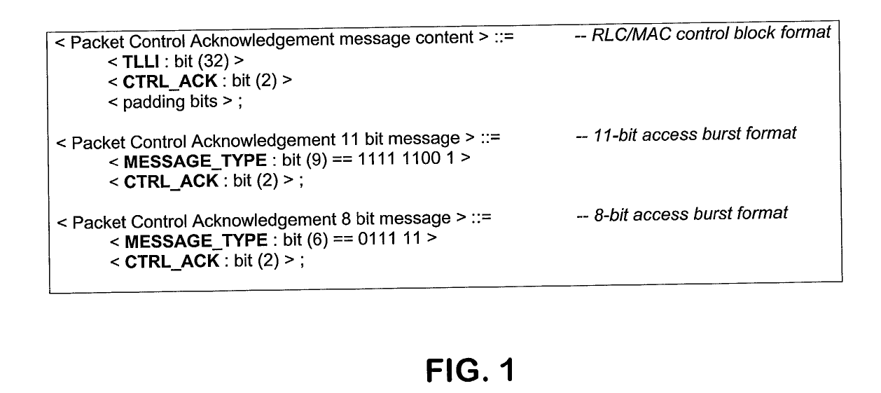

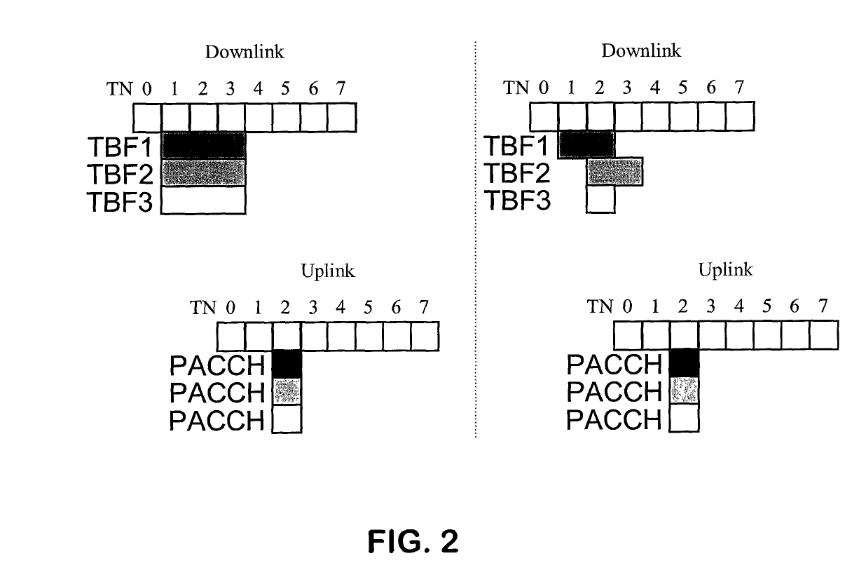

FIGS. 1 and 2 have already been described above.

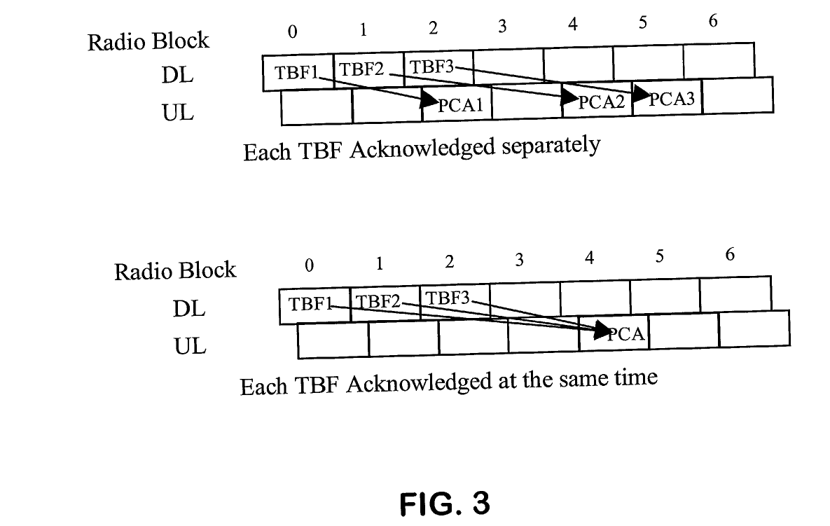

FIGS. 3 to 5 relate to a communication system in which a mobile terminal is enabled to access a 3G core network via a GERAN.

FIG. 3 schematically compares a conventional acknowledgement for multiple downlink TBFs transmitted from a GERAN to a mobile station with a possible acknowledgement for such multiple TBFs according to an embodiment of the invention.

The upper part of FIG. 3 illustrates the conventional acknowledgement of multiple TBFs. In a first row of this upper part, downlink DL radio blocks 0 to 6 are depicted, and in a second row, corresponding uplink UL radio blocks 0 to 6 are depicted.

In the downlink, three TBFs 1-3 assigned to the same mobile station are transmitted in consecutive radio blocks 0, 1 and 2. Each of the TBFs 1-3 comprises a downlink control message. Each of these downlink control messages comprises a valid RRBP field, which indicates that the mobile station is requested to acknowledge reception of the respective control message with a PCA message. The settings of the RRBP fields of the three TBFs 1-3 are further used for indicating for how long the mobile station has to wait before transmitting the respective PCA 1-3 in an uplink radio block. In accordance with the respectively indicated waiting periods, the first TBF 1 is acknowledged in uplink radio block 2 with PCA 1, the second TBF 2 in uplink radio block 4 with PCA 2 and the third TBF 3 in uplink radio block 5 with PCA 3. The association of the TBFs 1-3 to the PCAs 1-3 is also indicated in the figure by arrows. It is to be noted that the figure only illustrates the principle of separate acknowledgements known from the state of the art. The waiting periods required according to the RRBP fields before transmitting the respective PCA 1-3 do not correspond necessarily to the definitions in the above cited technical report TS 44.060.

The PCAs 1-3 do not contain any identification of the TBF 1-3 to which the acknowledgement is associated, since the network has control of the transmission of the PCAs. Thus it can be assumed that the network knows which downlink TBF 1-3 is to be acknowledged with which received PCA 1-3 based on the uplink radio block in which the PCA 1-3 is included.

The lower part of FIG. 3 illustrates the acknowledgement of multiple TBFs according to the invention. Again, downlink DL radio blocks 0 to 6 are depicted in a first row and corresponding uplink UL radio blocks 0 to 6 in a second row.

As in the first situation, three TBFs 1-3 assigned to the same mobile station are transmitted in consecutive downlink radio blocks 0, 1 and 2. Each of the TBFs 1-3 comprises again a downlink control message including with a valid RRBP field a polling requesting the mobile station to acknowledge reception of the respective control message with a PCA message. As in the conventional case, the RRBP field of each TBF 1-3 indicates for how long the mobile station has to wait before transmitting a PCA in an uplink radio block. In this case, however, the RRBP fields in the control message of every TBF 1-3 refer to the same uplink radio block for the PCA, namely to radio block 4. Therefore, the acknowledgements of the three TBFs 1-3 are adjusted to occur at the same uplink radio block 4. This means that a single uplink PCA message is used to acknowledge the reception of downlink control messages belonging to three different TBFs 1-3. The association of the TBFs 1-3 to a single PCA is indicated in the figure by arrows.

Since the uplink PCA in radio block 4 contains acknowledgement of several downlink control messages belonging to different TBFs 1-3, an identification of the TBFs 1-3 is included in the PCA. These identifications enable the network to identify each acknowledged TBF 1-3.

It becomes apparent from this example that the invention is suited to reduce the load in the uplink, since in contrast to the state of the art, only a single PCA message is used for acknowledging control messages of several downlink TBFs associated with the same mobile station.

As explained above with reference to FIG. 1, a PCA can be transmitted according to the cited technical report TS 44.060 using different formats, i.e. the RLC/MAC control block format and the 11 bit or 8 bit access burst format.

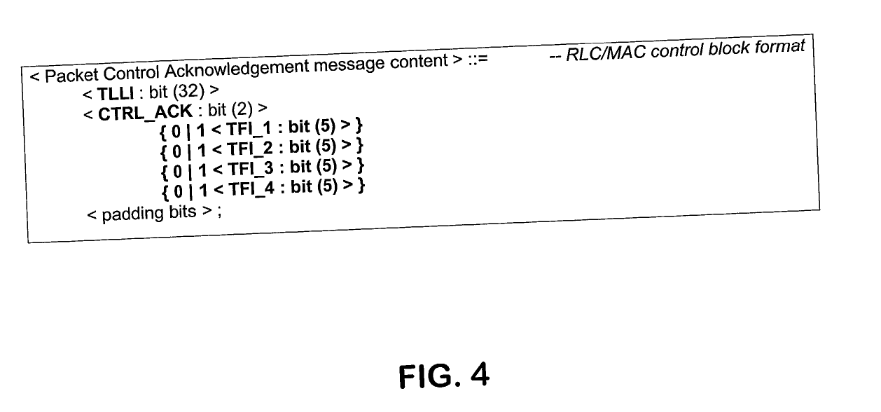

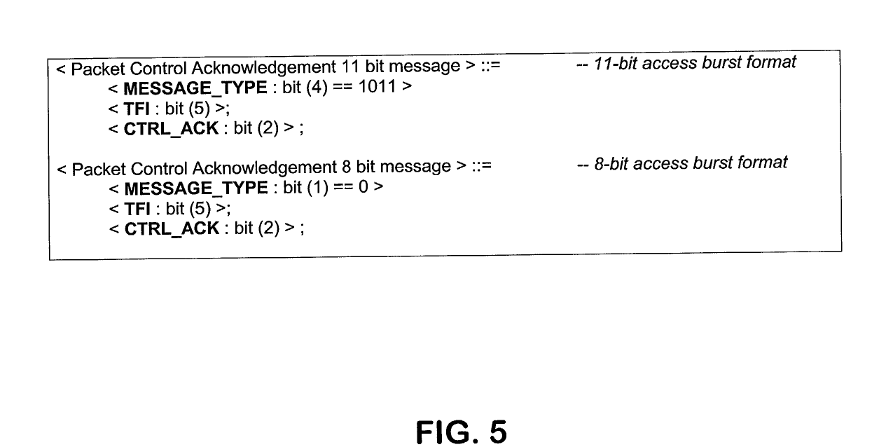

In the following, for each of these formats, an example for a new structure adapted to the requirements of the invention will be proposed with reference to FIGS. 4 and 5.

FIG. 4 is a table presenting a new RLC/MAC control block format that can be employed for transmitting a PCA acknowledging multiple downlink TBFs according to the invention.

The format of the new RLC/MAC control block is based on the RLC/MAC control block format specified in TS 44.060, which format was presented above with reference to the upper part of FIG. 1. Thus, also the new control block comprises a 32 bit TLLI field, a 2 bit CTRL_ACK field and padding bits.

In case control messages of more than one TBF are to be acknowledged with the same downlink PCA, however, the employed RLC/MAC control block contains in addition a TFI field for each TBF that is acknowledged. The TFIs fields are inserted between the CTRL_ACK field and the remaining padding bits. It is proposed that up to four 5 bit TFI fields can be inserted in each PCA message. Each included TFI field comprises the TFI of one of the TBFs of which a control message is to be acknowledged.

It is to be noted though, that is not necessarily required that each provided TFI field comprises the TFI of a different TBF. For example, in case two different downlink TBFs have to be acknowledged, an identifier of each TBF could be included in respective two of four provided TFI fields.

Alternatively to the TFI of each TBF that is to be acknowledged, the main timeslot number of the respective TBF could be used as an TBF identifier. In this case, timeslot-number fields would be included instead of the TFI fields. Also any other suitable identifier of TBFs could be used in a corresponding field.

FIG. 5 is a table presenting new access burst formats that can be employed for transmitting a PCA acknowledging multiple downlink TBFs according to the invention. In the upper part of FIG. 5, a new 11-bit access burst format is shown, and in the lower part, a new 8-bit access burst format is shown.

As the conventional 11-bit and 8-bit access burst formats that were described above with reference to the middle and the lower part of FIG. 1, the new formats comprise a MESSAGE_TYPE type field and a CTRL_ACK field. In contrast to the RLC/MAC control block format, however, in neither of the conventional access burst formats there are bits available for adding fields for identifying downlink TBFs of which reception is to be acknowledged.

Therefore, it is proposed that new MESSAGE_TYPE fields are defined, which new MESSAGE_TYPE fields require less bits and thus leave some bits available for additional fields. Since the PCA is sent on an uplink PACCH channel and only when requested by the mobile station, the message type does not be unique, i.e. very short indications of the message type can be used.

For the 11-bit access burst format, it is proposed that the MESSAGE_TYPE field contains only 4 bits instead of 9 bits, and for the 8-bit access burst format, it is proposed that the MESSAGE_TYPE field contains only 1 bit instead of 6 bits. Thus, in both cases a new field of 5 bits can be inserted between the message type field and the CTRL_ACK field. Obviously, other distributions of the available bits to the MESSAGE_TYPE field and a new field can be employed as well.

When using the access burst format, the mobile station sends one PCA in the four consecutive TDMA frames of the assigned radio block. This enables the mobile station to transmit with each repetition an acknowledgement for a different TBF. It would also be possible to use for each repetition of the PCA a different code. In the new TFI field of 5 bits in both access burst formats, the respectively acknowledged TBF can be identified by the TFI associated to the TBF. Thus, each of the PCAs in the four consecutive TDMA frames may contain a different TFI value.

In case less than four downlink TBFs are to be acknowledged, the identification of one or two TBFs could be transmitted repeatedly. For example, if two downlink TBFs are assigned to a mobile station, two of the PCAs in the four consecutive TDMA frames might comprise the TFI of the first TBF, while the other two PCAs in the four consecutive TDMA frames might include the TFI of the second TBF.

Alternatively to the TFI, again the main timeslot number or any other TBF identifier could be used as an TBF identifier.

An alternative possibility of a new coding of the 11 bit or 8 bit access burst format would be for instance to include two TBF identifiers in each PCA, similar as proposed with the RLC/MAC control block format.

While there have shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for acknowledging reception of messages in a communications system, which messages are downlink messages transmitted from a communication network to a mobile station connected to said communication network, wherein said method comprises:
receiving at said mobile station at least two downlink messages from said communication network, of which at least two downlink messages reception has to be acknowledged; and
acknowledging reception of said at least two downlink messages in a single uplink message transmitted by said mobile station to said communication network.

2. A method according to claim 1, wherein said communication network comprises a GSM/EDGE (Global system for mobile communications/enhanced data rates for GSM evolution) radio access network (GERAN) via which said mobile station is connected to said communication network.

3. A method according to claim 1, wherein said at least two downlink messages are control messages transmitted in at least two downlink temporary block flows (TBF) associated to said mobile station.

4. A method according to claim 1, wherein said uplink message is transmitted in an uplink control channel associated to a downlink temporary block flow (TBF), which downlink TBF is associated to said mobile station.

5. A method according to claim 4, wherein said uplink message is transmitted as a single packet control acknowledgement (PCA) message on a reserved uplink radio block of four consecutive time division multiple access (TDMA) frames of said control channel.

6. A method according to claim 1, wherein an uplink radio block that is to be employed for transmitting said uplink message acknowledging reception of said at least two downlink messages is identified in each of said at least two downlink messages.

7. A method according to claim 1, wherein said uplink message acknowledging reception of said at least two downlink messages comprises an identification of each of said at least two downlink messages.

8. A method according to claim 7, wherein said at least two downlink messages are control messages transmitted in at least two downlink temporary block f lows (TBF), and wherein said identification comprises at least a temporary block flow identifier (TFI) assigned to each TBF.

9. A method according to claim 7, wherein said at least two downlink messages are control messages transmitted in at least two downlink temporary block flows (TBF), and wherein said identification comprises at least a timeslot number of a predetermined timeslot of each TBF.

10. A method according to claim 1, wherein said uplink message is transmitted using a radio link control/medium access control (RLC/MAC) control block format.

11. A method according to claim 10, wherein said RLC/MAC control block format provides at least two identification fields, and wherein at least two of said at least two identification fields identify a different one of said at least two downlink messages that are to be acknowledged by said single uplink message.

12. A method according to claim 1, wherein said uplink message is transmitted using an access burst format.

13. A method according to claim 12, wherein a burst used for said uplink message and defined by said access burst format is transmitted four times in four consecutive time division multiple access (TDMA) frames, and wherein each acknowledgment of reception of up to four downlink messages is included in a different one of said bursts in said four consecutive frames.

14. A mobile station comprising means for combining acknowledgements for at least two downlink messages received from a communication network to which said mobile station is connected into a single uplink message to said communication network.

15. A communication network comprising means for transmitting downlink messages to a mobile station connected to said communication network, and means for requesting an acknowledgement of at least two downlink messages transmitted to said mobile station with a single uplink message.

16. A communication network according to claim 15, comprising at least a GERAN and a 3G core network, said GERAN providing access for mobile stations to said 3G core network.

17. A communication system comprising:
a communication network with means for transmitting downlink messages to a mobile station connected to said communication network and with means for requesting an acknowledgement of at least two downlink messages transmitted to said mobile station with a single uplink message; and
a mobile station with means for combining acknowledgements for at least two downlink messages received from said communication network into a single uplink message to said communication network.
